(19) United States
(12) Patent Application Publication
(10) Pub. No.: US 2014/0089209 A1
(43) Pub. Date: Mar. 27, 2014

(54) METHODS AND SYSTEMS FOR LINKING BUILDING INFORMATION MODELS WITH BUILDING MAINTENANCE INFORMATION

(71) Applicant: Carnegie Mellon University, Pittsburgh, PA (US)

(72) Inventors: Asli Akcamete, Ankara (TR); Burcu Akinci, Pittsburgh, PA (US); Xuesong Liu, Pittsburgh, PA (US); James H. Garrett, JR., Pittsburgh, PA (US)

(73) Assignee: Carnegie Mellon University, Pittsburgh, PA (US)

(21) Appl. No.: 14/038,598

(22) Filed: Sep. 26, 2013

Related U.S. Application Data
(60) Provisional application No. 61/744,437, filed on Sep. 26, 2012.

(51) Int. Cl. G06Q 10/00

(52) U.S. Cl. CPC G06Q 10/20
USPC 705/305

(57) ABSTRACT

A computer-implemented method includes, in one aspect, receiving a request for a spatial analysis of building behavior of an entity within a building facility; retrieving building maintenance information about the entity within the building facility; accessing a building information model for the building facility; identifying a portion of the building information model that pertains to the entity; and based on the retrieved building maintenance information and the identified portion of the building information model, generating the spatial analysis of the building behavior for the entity within the building facility.

### CROSS-REFERENCE TO RELATED APPLICATIONS

This application claims the benefit of priority under 35 U.S.C. §119(e) to provisional U.S. Patent Application No. 61/744,437, filed on Sep. 26, 2012, the entire contents of which are hereby incorporated by reference.

### FIELD OF USE

The present disclosure relates to analyzing and presenting building maintenance information for facilities management.

### BACKGROUND

Throughout the life-cycle of a facility, the largest fraction of the expenses occurs during the operations phase. Less than 15% of the total cost is incurred during design and construction, whereas the longest phase of the lifecycle, operations, constitutes approximately 60% of the total cost. A major set of activities during operations is related to the maintenance and repair (M&R) of the facility, and excessive expenses could occur when reactive maintenance and repairs are performed. Reactive maintenance tasks can cost three to four times more than the same repair activity if it were to be performed as planned maintenance. Moreover, since reactive maintenance typically targets the repair of current symptoms but not the root cause of the breakdown, it can further increase the frequency and costs of repairs and maintenance. Supporting more planned and condition-based maintenance work (preventive, predictive, or reliability-centered maintenance), rather than reacting to failures, can contribute to cost savings during the operations phase.

### SUMMARY

The present disclosure describes methods and systems relating to analysis and presentation of building maintenance information. Building maintenance information, such as data from work orders, may be linked to a building information model (BIM) for integration of information generated from design, construction, and operation of the building. The building maintenance information may be analyzed and presented in view of the building information model. Such analysis and presentation of the building maintenance information may enable a user to identify spatial trends for each type of repair activity and spatial relationships between different types of activities so that predictive and proactive maintenance and repair activities can be undertaken.

In one aspect of the present disclosure, a computer-implemented method includes receiving a request for a spatial analysis of building behavior of an entity within a building facility; retrieving building maintenance information about the entity within the building facility; accessing a building information model for the building facility, with the building information model comprising a representation of one or more of a physical characteristic and a functional characteristic of the entity within the building facility; identifying a portion of the building information model that pertains to the entity; and based on the retrieved building maintenance information and the identified portion of the building information model, generating the spatial analysis of the building behavior for the entity within the building facility; wherein the spatial analysis comprises: a representation of the building maintenance information; and a representation of the one or more of the physical characteristic and the functional characteristic of the entity within the building facility; with the representation of the building maintenance information being an overlay to the representation of the one or more of the physical characteristic and the functional characteristic of the entity within the building facility.

Implementations of the disclosure can include one or more of the following features. The method may include generating, in a data repository, an association between the retrieved building maintenance information and the identified portion of the building information model. Generating the association comprises: associating the building maintenance information with a unique identifier included in the identified portion of the building information model. The entity comprises one or more of a space, a component, and a set of components within the building facility. The spatial analysis comprises statistical information about the entity. The method may include determining a number of maintenance activities for the entity; wherein the representation of the building maintenance information comprises information indicative of the number of maintenance activities for the entity. The method may include determining a cost of one or more maintenance activities for the entity; wherein the representation of the building maintenance information comprises information indicative of the cost of the one or more maintenance activities for the entity. The representation of the building maintenance information comprises a visual representation of the building maintenance information; and the representation of the one or more of the physical characteristic and the functional characteristic of the entity within the building facility comprises a visual representation of the one or more of the physical characteristic and the functional characteristic of the entity within the building facility.

All or part of the foregoing may be implemented as a computer program product including instructions that are stored on one or more non-transitory machine-readable storage media, and that are executable on one or more processing devices. All or part of the foregoing may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description, the drawings, and the claims.

### BRIEF DESCRIPTION OF THE FIGURES

FIG. 1 is a data flow diagram of maintenance and repair (M&R) information collection and integration with a facilities management building information model (FM BIM).

FIG. 2 is a block diagram of an example of a network environment for analyzing and presenting building maintenance information.

FIG. 3 is a block diagram of examples of components of the network environment of FIG. 2.

FIG. 4 shows a unified modeling language (UML) diagram of instances of work orders and instances of building entities.

FIG. 5 shows an example of a color map that can be used to graphically present the amount of work orders that are related to the spaces and components in the BIM.

FIG. 6 shows examples of static line charts that show the weekly number of hot/cold calls and thermostat re-calibration work orders.

FIG. 7 is a flowchart of an example of a process for analyzing and presenting building maintenance information.

### DETAILED DESCRIPTION

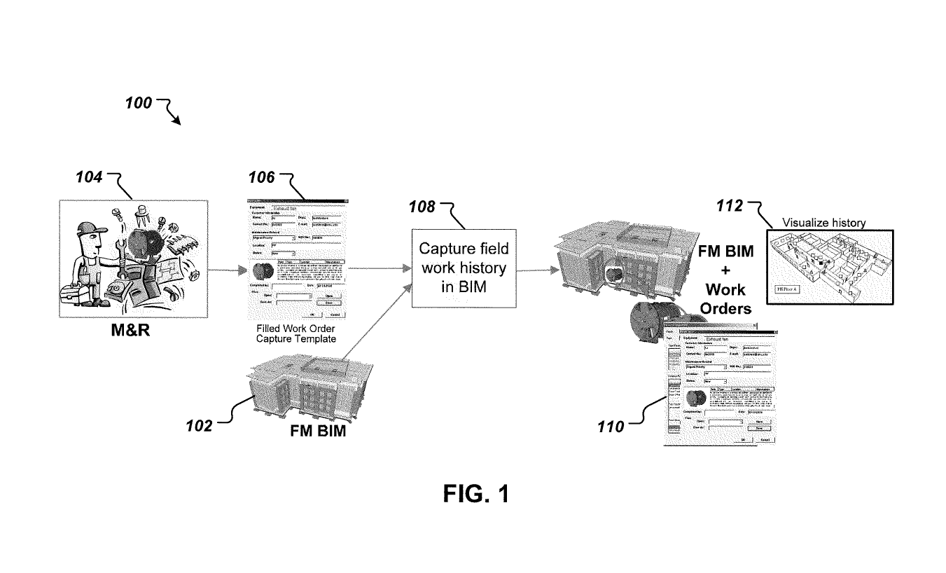

The present disclosure describes systems and methods relating to analysis and presentation of building maintenance information in view of a building information model (BIM). FIG. 1 is a data flow diagram 100 of maintenance and repair (M&R) information collection and integration with a facilities management building information model (FM BIM) 102. The BIM 102 may support various processes such as design, estimation, and coordination during different phases of the building life cycle. The BIM may store semantic information about the facility, such as spatial information, asset information, and spatial and topological relationships between components, and provide three-dimensional spatial information about the building and its components.

The building M&R information may include information about tasks 104 happening in the facilities during operation and maintenance (O&M). Tasks 104 may include, for example, replacements, installations, and status changes (e.g., unclog, clean, switch off, and reset). O&M task information may be captured by generating customized templates 106 to record the task information. The O&M task information may be stored within the BIM 102 as integrated facility information 108. Capturing information about O&M tasks 104 may allow storing a history of facility changes and a record of the facility performance. Daily facility management (FM) operations may be tracked to provide data for financial analysis and maintenance work prioritization. The building maintenance information may be linked to the BIM 102 to provide access to up-to-date facility information 110 depicting the as-is conditions of the facility and a history of changes that have occurred in the facility and to provide a visual presentation 102 of O&M activities and spatial analysis of building behavior. The visual presentation 102 can enable a user to identify patterns of breakdowns for a particular area of a building and spatial relationships in work orders for maintenance execution and planning.

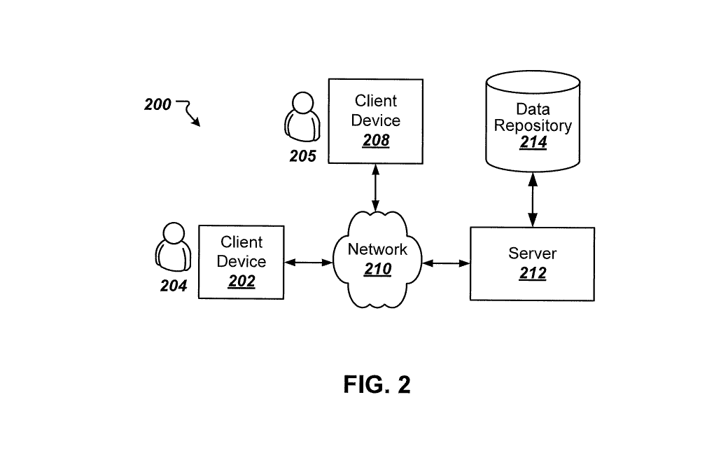

FIG. 2 is a block diagram of an example of a network environment 200 for analyzing and presenting building maintenance information. Network environment 200 includes client devices 202 and 208, network 210, server 212, and data repository 214.

The client device 202 is used by a user 204, such as an engineer. The user 204 may use the client device 202 to manage a BIM and M&R information about a building. The client device 202 sends the BIM and M&R information to the server 212. The server 212 may store the BIM and M&R information in a data repository 214.

The client device 208 is used by user 205, such as a facilities manager. The client device 208 may receive up-to-date facility information and analysis results. The client device 208 may present the information and results to the user 205 on a display device of the client device 208.

The server 212 is a system for collecting and integrating M&R information with a BIM and providing the integrated information and analysis results to a user. The server 112 may retrieve M&R information and a BIM from the data repository 214 and link the M&R information to the BIM. The server 112 may provide the integrated information and analysis results to a user as a visual presentation of O&M activities and spatial analysis of building behaviour.

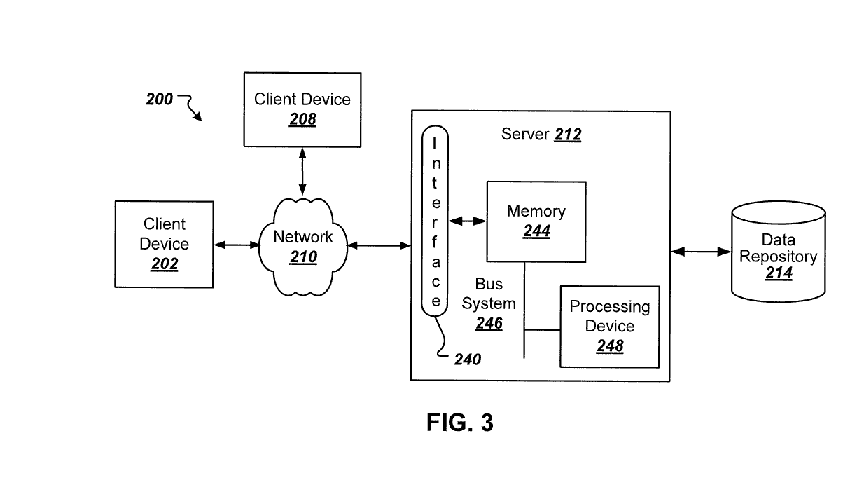

FIG. 3 is a block diagram of examples of components of the network environment 200 of FIG. 2. In FIG. 3, the client devices 202 and 208 can be any sort of computing devices capable of taking input from a user and communicating over network 210 with server 212 and/or with other client devices. For example, the client devices 202 and 208 can be mobile devices, desktop computers, laptops, cell phones, personal digital assistants (“PDAs”), servers, embedded computing systems, and so forth.

Server 212 can be any of a variety of computing devices capable of receiving data, such as a server, a distributed computing system, a desktop computer, a laptop, a cell phone, a rack-mounted server, and so forth. Server 212 may be a single server or a group of servers that are at a same location or at different locations.

The illustrated server 212 can receive data from the client devices 202 and 208 via input/output (“I/O”) interface 240. I/O interface 240 can be any type of interface capable of receiving data over a network, such as an Ethernet interface, a wireless networking interface, a fiber-optic networking interface, a modem, and so forth. Server 212 also includes a processing device 248 and memory 244. A bus system 246, including, for example, a data bus and a motherboard, can be used to establish and to control data communication between the components of server 212.

The illustrated processing device 248 may include one or more microprocessors. Generally, processing device 248 may include any appropriate processor and/or logic that is capable of receiving and storing data, and of communicating over a network (not shown). Memory 244 can include a hard drive and a random access memory storage device, such as a dynamic random access memory, or other types of non-transitory machine-readable storage devices. Memory 244 stores computer programs (not shown) that are executable by processing device 248 to perform the techniques described herein.

M&R information may be communicated and stored by generating work orders (WOs). The information stored in a work order may provide feedback about problems occurring in a facility and the remedies taken for resolving them. Capturing all the relevant information in WOs may be useful for tracking the maintenance, repairs, and changes done in a facility. Table 1 provides two typical examples of WOs and information that may be captured using the WOs.

TABLE 1

| | Work order 1 (WO1) | Work order 2 (WO2) |
|---|---|---|
| Name | Replace a leaky pipe | Repair the supply fan in |
| | | an AHU |
| Request Date | May 20, 2011 | Jun. 01, 2011 |
| Finish Date | May 26, 2011 | Jun. 03, 2011 |
| Type | Replace | Repair |
| Location | Room 105 | Mechanical room A11 |
| Component(s) | Pipe, dry wall | Supply fan |
| Shop/Trade | Plumber, Carpenter | Electrician |
| Description | Pipe's leaky section | The supply fan in AHU 2 |
| | was replaced and the | has a belt-relaxation |
| | wall cut to access the | fault and was repaired. |
| | pipe was replaced. | |
| Labor Hour | 13:00 | 6:30 |
| Labor Cost | $530.18 | $162.50 |
| Material Cost | $55.00 | $198.99 |
| Total Cost | $585.18 | $361.49 |

Table 1 depicts two example work orders: WO1 includes information related to replacing a leaky pipe, and WO2 includes information related to repairing a supply fan in an air-handling unit (AHU). The types of information captured in the WOs include Name (or short description) and Description, Request and Finish Date, Type of the work, Location of the work, Shop that performed the work, Components that were maintained or repaired, Labor hours spent for the work, and Labor, Material, and Total Costs for the work. WO1 is performed in Room 105 from May 20th to 26^{th} and involved repair of a pipe due to a water leak and replacement of a section of the dry wall that had to be removed so as to access and replace the pipe section. A plumber and a carpenter worked on this repair for 13 hours at a labor cost of $530.18 and a total material cost of $55. WO2 is a repair of the supply fan belt in mechanical room A11, which was reported as a problem on June 1st and was repaired by June 3rd. The electrician fixed the belt-relaxation problem in 6.5 hours, charged $162.50, and had used $198.99 worth of material for the repair.

Linking two information sources may include identifying the information items that are represented by both sources and mapping the values of the common information items in a consistent way. There are two common information items in both the BIM and work orders: location of the work order and components that are associated with the work order. As shown in Table 1, among the information items contained in a work order, Location and Components indicate the spatial information of the work order.

For instance, in Table 1, WO1 describes the task of replacing a leaking pipe. A facility manager had to find and inspect the spaces that were below the leaking area to find out whether they were affected. These spaces can be found using the Location information of WO1, which indicates that the leakage took place in Room 105. In current practice, field workers can either look at the floor plan of the building or go to the building to find which spaces are below Room 105.

Similarly, WO2 describes the task of repairing the supply fan of an AHU. Since repairing the supply fan affects the normal performance of the entire AHU and all spaces that are served by it, a facility manager had to find out what spaces were affected and warn the occupants about the repair work. According to the information item Components of the WO2, that facility manager can search in a mechanical drawing of the building to find out which spaces are associated with the supply fan.

Since the information in the Location and Components fields of a work order are also represented in the BIM, the work orders can be linked with the BIM using these two information items. In the BIM, entities such as the spaces, walls, ducts, and equipment may have global unique identifiers (GUID). Using a GUID-based approach may ensure that different spaces and components do not have repeated names, and may ensure a consistent naming convention. To ensure the consistency of the linkage between the BIM and work order information, the linkage between work order and the BIM may be implemented by associating the work order with the ID of spaces and building components in the BIM.

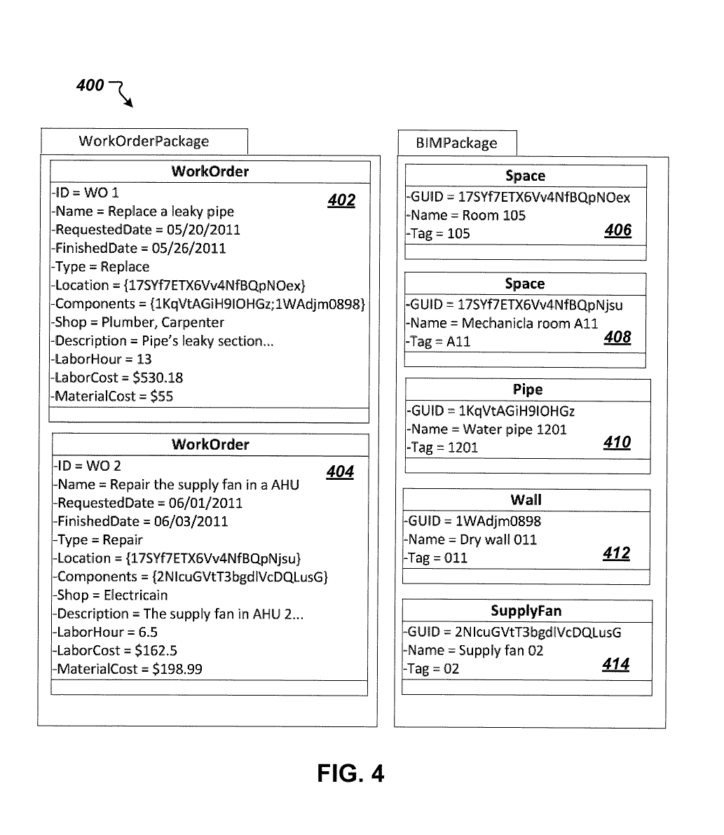

FIG. 4 shows a unified modeling language (UML) diagram 400 of instances of work orders 402 and 404 and instances of building entities 406, 408, 410, 412, and 414. The UML diagram 400 shows the simplified information of the work orders and building entities to illustrate the linkage between work orders and the BIM. In the UML diagram 400, the WorkOrderPackage contains the instances of class WorkOrder, which stores the information of each work order. The BIMPackage contains the instances of classes in the BIM. In this simplified example, only the instances of the building entities that are directly related to the two work orders are described. The two instances 402 and 404 of WorkOrder class contain the information that is described in Table 1. The difference between the contents in the table and diagram is that instead of storing the name of the associated spaces and building entities, the work order instances 402 and 404 only store the entities' GUID. If information about the spaces and components is needed, it can be queried from the BIM directly since the GUID is unchangeable for the entities in the BIM. For example, using the GUID of the Components in WO1, the associated components “Water pipe 1201” and “Dry wall 011” can be accessed from the BIM and the relevant information can be retrieved.

Linking work orders with the BIM may enable spatial and temporal analysis of work order records. Spatial analysis aims to compare the number or cost of maintenance tasks that have been done in different parts of the building. For example, if a supply fan has more repair work orders than other ones in the same floor, it may suggest that the supply fan may be aged and replacing the supply fan may be cheaper than enduring frequent repairs. Temporal analysis aims to show the trend of work order history so that abnormal conditions of building components can be identified. For instance, if the monthly count of hot calls from one space rises from two to eight, it may suggest that the temperature control system that serves that space may have faults and needs to be inspected. Spatiotemporal analysis provides trends of repairs over time to specific components or spaces, which can be correlated to building context. For example, a pattern showing that more light replacements were needed for rooms without windows may indicate a continuous need for artificial light. Analyzing the M&R information within the BIM context may enable a user to assess spatial relationships between different M&R activities. For example, a pattern showing that most of the floor cleaning/replacement work were performed in rooms with ceiling tile replacements may aid a user in assessing whether floor cleaning or replacements can be reduced by solving the ceiling problems in those rooms.

A user may query the WO information linked with the BIM based on different information categories stored in the WOs (such as type, cost, and shop) and building components related information (such as type and location). Spatial and temporal patterns of WOs can be queried and displayed to get further insights about the previous WOs in the facility. The analysis results may be displayed using, for example, sentences, which directly describe the data in plain text, text or numeric tables, which list the data in columns and rows, and graphics, which visualize data in figures. Tables may be used to show quantitative data, while graphs may be used to show qualitative information, such as an increasing or decreasing trend and a comparison of multiple data sets.

Graphical presentation of a data comparison may enable a user to identify abnormal behavior of maintenance history on certain spaces or components. For example, if most of the spaces have two repair work orders per month and one space has nine repair work orders, the cause of these work orders in that space may possibly be atypical. Data comparison enables a user to identify clusters of data sets that have a qualitative difference. According to the requirements of the user, the cluster can be categorized into a different number of levels, such as a rating scale. For example, to compare the monthly cost of work orders in each space in five cost range levels, a facility manager can divide the maximum monthly cost by five and categorize the spaces into each group. A color map may be used to graphically present the comparison of the number of, or the cost of, work orders for each space or component.

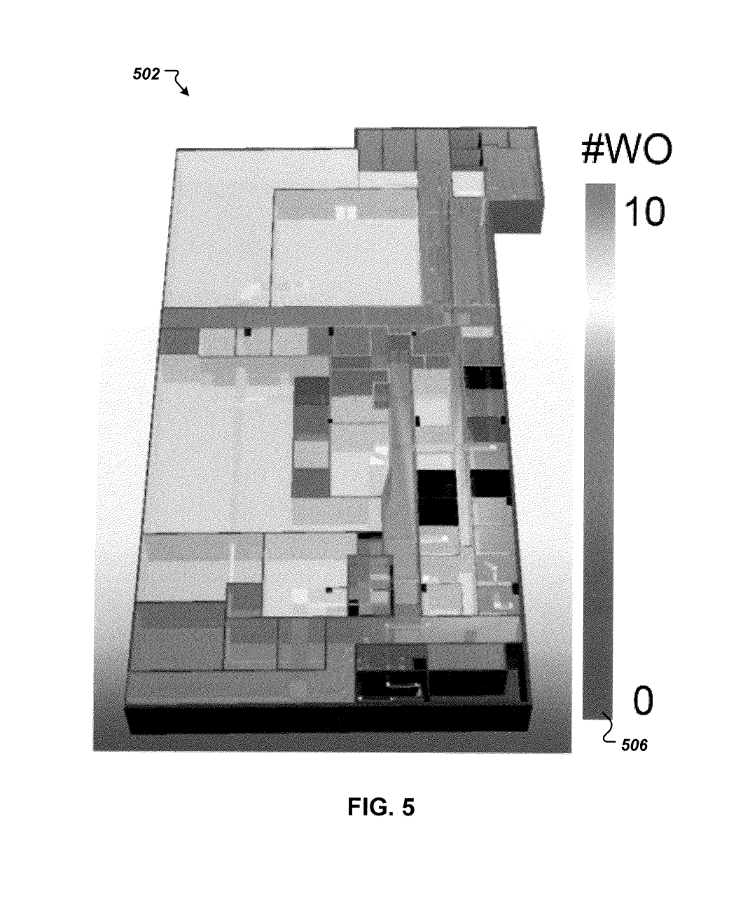

FIG. 5 shows an example of a color map 502 that can be used to graphically present the amount of work orders that are related to the spaces and components in the BIM. In the color map 502, the spaces that are related to the largest number of work orders are colored in red and the spaces that are related to the fewest number of work orders are colored in blue. The other spaces with numbers of WOs in between are colored with a color based on the gradient given in the gradient map 506 for the color map 502. Color map 502 shows the distribution of the work orders and may enable a user to identify the problematic spaces in an intuitive way.

Data trending analyzes the time-series of the data to show an increasing or decreasing trend in the data. Time-series visualization approaches can be categorized into two groups: static charts and animation. Static charts include line charts, small multiples, and horizontal graphs. Static charts can be used to show the trend of single or multiple variables in one graph at one time. For example, a static line chart may be used to show the work order history in a single room or component for a relatively long period. Animation can be used to show multiple variables in a dynamic way so that the data at one time point is visualized in the graph at a time. Animation may be used to show trends in a larger number of variables.

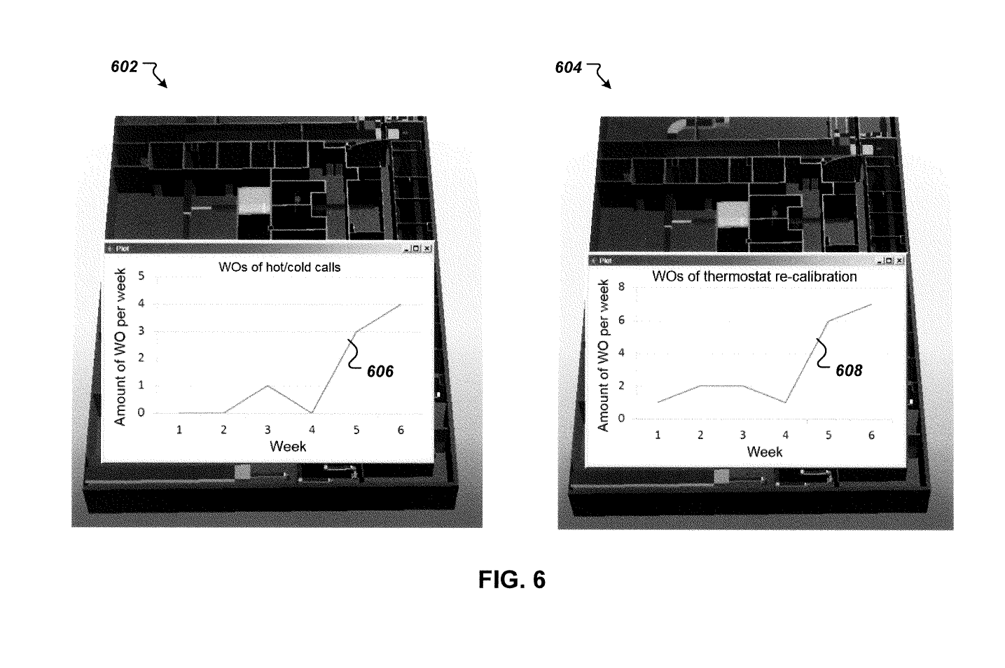

FIG. 6 shows examples of static line charts 602 and 604. In the static line chart 602, the curve 606 represents the weekly number of hot/cold calls. In the static line chart 604, the curve 608 represents the weekly number of thermostat re-calibration work orders.

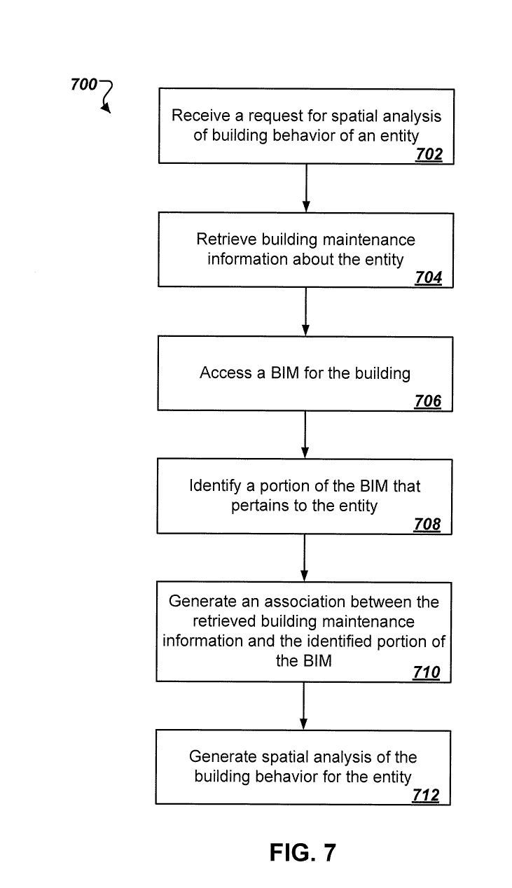

FIG. 7 is a flowchart of an example of a process 700 for analyzing and presenting building maintenance information. The process 700 may be performed by a system of one or more computers, such as server 212 of FIGS. 2 and 3. The process 700 may include details that have discussed above.

The system receives a request for a spatial analysis of building behavior of an entity within a building facility (702). The entity may include a space, a component, a set of components within the building facility, or a combination.

The system retrieves building maintenance information about the entity within the building facility (704) and accesses a building information model (BIM) for the building facility (706). The system identifies a portion of the building information model that pertains to the entity (708). The building information model may include a representation of a physical characteristic, a functional characteristic, or both of the entity within the building facility.

The system may generate an association between the retrieved building maintenance information and the identified portion of the building information model (710). The system may generate the association by associating the building maintenance information with a unique identifier included in the identified portion of the building information model.

The system generates the spatial analysis of the building behavior for the entity within the building facility based on the retrieved building maintenance information and the identified portion of the building information model (712). The spatial analysis may include statistical information about the entity. The spatial analysis may include a representation, e.g., a visual representation, of the building maintenance information. For example, the spatial analysis may include determining a number of maintenance activities for the entity, and the representation of the building maintenance information may include information indicative of the number of maintenance activities for the entity. As another example, the spatial analysis may include determining a cost of one or more maintenance activities for the entity, and the representation of the building maintenance information may include information indicative of the cost of the one or more maintenance activities for the entity. The spatial analysis may include a representation, e.g., a visual representation, of the physical characteristic, the functional characteristic, or both of the entity within the building facility. The representation of the building maintenance information may be an overlay to the representation of the one or more of the physical characteristic and the functional characteristic of the entity within the building facility.

Embodiments can be implemented in digital electronic circuitry, or in computer hardware, firmware, software, or in combinations thereof. An apparatus can be implemented in a computer program product tangibly embodied or stored in a machine-readable storage device for execution by a programmable processor; and method actions can be performed by a programmable processor executing a program of instructions to perform functions by operating on input data and generating output. The embodiments described herein, and other embodiments of the invention, can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object oriented programming language, or in assembly or machine language if desired; and in any case, the language can be a compiled or interpreted language.

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer readable media for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry. Any of the foregoing can be supplemented by, or incorporated in, ASICs (application-specific integrated circuits).

To provide for interaction with a user, embodiments can be implemented on a computer having a display device, e.g., a LCD (liquid crystal display) monitor, for displaying data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation of embodiments, or any combination of such back end, middleware, or front end components. The components of the system can be interconnected by any form or medium of digital data communication, e.g., a communication network. Examples of communication networks include a local area network (LAN) and a wide area network (WAN), e.g., the Internet.

The system and method or parts thereof may use the “World Wide Web” (Web or WWW), which is that collection of servers on the Internet that utilize the Hypertext Transfer Protocol (HTTP). HTTP is a known application protocol that provides users access to resources, which may be data in different formats such as text, graphics, images, sound, video, Hypertext Markup Language (HTML), as well as programs. Upon specification of a link by the user, the client computer makes a TCP/IP request to a Web server and receives data, which may be another Web page that is formatted according to HTML. Users can also access other pages on the same or other servers by following instructions on the screen, entering certain data, or clicking on selected icons. It should also be noted that any type of selection device known to those skilled in the art, such as check boxes, drop-down boxes, and the like, may be used for embodiments using web pages to allow a user to select options for a given component. Servers run on a variety of platforms, including UNIX machines, although other platforms, such as Windows 2000/2003, Windows NT, Windows 7, Windows 8, Sun, Linux, and Macintosh may also be used. Computer users can view data available on servers or networks on the Web through the use of browsing software, such as Firefox, Netscape Navigator, Microsoft Internet Explorer, or Mosaic browsers. The computing system can include clients and servers. A client and server are generally remote from each other and typically interact through a communication network. The relationship of client and server arises by virtue of computer programs running on the respective computers and having a client-server relationship to each other.

Other embodiments are within the scope and spirit of the description claims. Additionally, due to the nature of software, functions described above can be implemented using software, hardware, firmware, hardwiring, or combinations of any of these. Features implementing functions may also be physically located at various positions, including being distributed such that portions of functions are implemented at different physical locations. The use of the term “a” herein and throughout the application is not used in a limiting manner and therefore is not meant to exclude a multiple meaning or a “one or more” meaning for the term “a.” Additionally, to the extent priority is claimed to a provisional patent application, it should be understood that the provisional patent application is not limiting but includes examples of how the techniques described herein may be implemented.

A number of exemplary embodiments of the invention have been described. Nevertheless, it will be understood by one of ordinary skill in the art that various modifications may be made without departing from the spirit and scope of the invention.

What is claimed is:

1. A computer-implemented method comprising:
receiving a request for a spatial analysis of building behavior of an entity within a building facility;
retrieving building maintenance information about the entity within the building facility;
accessing a building information model for the building facility, with the building information model comprising a representation of one or more of a physical characteristic and a functional characteristic of the entity within the building facility;
identifying a portion of the building information model that pertains to the entity; and
based on the retrieved building maintenance information and the identified portion of the building information model, generating the spatial analysis of the building behavior for the entity within the building facility;
wherein the spatial analysis comprises:
a representation of the building maintenance information; and
a representation of the one or more of the physical characteristic and the functional characteristic of the entity within the building facility;
with the representation of the building maintenance information being an overlay to the representation of the one or more of the physical characteristic and the functional characteristic of the entity within the building facility.

2. The computer-implemented method of claim 1, further comprising:
generating, in a data repository, an association between the retrieved building maintenance information and the identified portion of the building information model.

3. The computer-implemented method of claim 2, wherein generating the association comprises:
associating the building maintenance information with a unique identifier included in the identified portion of the building information model.

4. The computer-implemented method of claim 1, wherein the entity comprises one or more of a space, a component, and a set of components within the building facility.

5. The computer-implemented method of claim 1, wherein the spatial analysis comprises statistical information about the entity.

6. The computer-implemented method of claim 1, further comprising:
determining a number of maintenance activities for the entity;
wherein the representation of the building maintenance information comprises information indicative of the number of maintenance activities for the entity.

7. The computer-implemented method of claim 1, further comprising:
determining a cost of one or more maintenance activities for the entity;
wherein the representation of the building maintenance information comprises information indicative of the cost of the one or more maintenance activities for the entity.

8. The computer-implemented method of claim 1, wherein the representation of the building maintenance information comprises a visual representation of the building maintenance information; and
wherein the representation of the one or more of the physical characteristic and the functional characteristic of the entity within the building facility comprises a visual representation of the one or more of the physical characteristic and the functional characteristic of the entity within the building facility.

9. A system comprising:
one or more processing devices; and
one or more computer-readable media storing instructions that are executable by the one or more processing devices to perform operations comprising:
receiving a request for a spatial analysis of building behavior of an entity within a building facility;
retrieving building maintenance information about the entity within the building facility;
accessing a building information model for the building facility, with the building information model comprising a representation of one or more of a physical characteristic and a functional characteristic of the entity within the building facility;
identifying a portion of the building information model that pertains to the entity; and
based on the retrieved building maintenance information and the identified portion of the building information model, generating the spatial analysis of the building behavior for the entity within the building facility;
wherein the spatial analysis comprises:
a representation of the building maintenance information; and
a representation of the one or more of the physical characteristic and the functional characteristic of the entity within the building facility;
with the representation of the building maintenance information being an overlay to the representation of the one or more of the physical characteristic and the functional characteristic of the entity within the building facility.

10. The system of claim 9, wherein the operations further comprise:
generating, in a data repository, an association between the retrieved building maintenance information and the identified portion of the building information model.

11. The system of claim 9, wherein generating the association comprises:
associating the building maintenance information with a unique identifier included in the identified portion of the building information model.

12. The system of claim 9, wherein the entity comprises one or more of a space, a component, and a set of components within the building facility.

13. The system of claim 9, wherein the spatial analysis comprises statistical information about the entity.

14. The system of claim 9, wherein the operations further comprise:
determining a number of maintenance activities for the entity;
wherein the representation of the building maintenance information comprises information indicative of the number of maintenance activities for the entity.

15. The system of claim 9, wherein the operations further comprise:
determining a cost of one or more maintenance activities for the entity;
wherein the representation of the building maintenance information comprises information indicative of the cost of the one or more maintenance activities for the entity.

16. The system of claim 9, wherein the representation of the building maintenance information comprises a visual representation of the building maintenance information; and
wherein the representation of the one or more of the physical characteristic and the functional characteristic of the entity within the building facility comprises a visual representation of the one or more of the physical characteristic and the functional characteristic of the entity within the building facility.

17. One or more computer-readable media storing instructions that are executable by one or more processing devices to perform operations comprising:
receiving a request for a spatial analysis of building behavior of an entity within a building facility;
retrieving building maintenance information about the entity within the building facility;
accessing a building information model for the building facility, with the building information model comprising a representation of one or more of a physical characteristic and a functional characteristic of the entity within the building facility;
identifying a portion of the building information model that pertains to the entity; and
based on the retrieved building maintenance information and the identified portion of the building information model, generating the spatial analysis of the building behavior for the entity within the building facility;
wherein the spatial analysis comprises:
a representation of the building maintenance information; and
a representation of the one or more of the physical characteristic and the functional characteristic of the entity within the building facility;
with the representation of the building maintenance information being an overlay to the representation of the one or more of the physical characteristic and the functional characteristic of the entity within the building facility.

18. The one or more computer-readable media claim 17, wherein the operations further comprise:
generating, in a data repository, an association between the retrieved building maintenance information and the identified portion of the building information model.

19. The one or more computer-readable media claim 17, wherein generating the association comprises:
associating the building maintenance information with a unique identifier included in the identified portion of the building information model.

20. The one or more computer-readable media claim 17, wherein the entity comprises one or more of a space, a component, and a set of components within the building facility.

21. The one or more computer-readable media claim 17, wherein the spatial analysis comprises statistical information about the entity.

22. The one or more computer-readable media claim 17, wherein the operations further comprise:
determining a number of maintenance activities for the entity;
wherein the representation of the building maintenance information comprises information indicative of the number of maintenance activities for the entity.

23. The one or more computer-readable media claim 17, wherein the operations further comprise:
determining a cost of one or more maintenance activities for the entity;
wherein the representation of the building maintenance information comprises information indicative of the cost of the one or more maintenance activities for the entity.

24. The one or more computer-readable media claim 17, wherein the representation of the building maintenance information comprises a visual representation of the building maintenance information; and
wherein the representation of the one or more of the physical characteristic and the functional characteristic of the entity within the building facility comprises a visual representation of the one or more of the physical characteristic and the functional characteristic of the entity within the building facility.
